(19) United States
(12) Patent Application Publication
(10) Pub. No.: US 2004/0114644 A1
(43) Pub. Date: Jun. 17, 2004

(54) Tunable wavelength semiconductor laser diode

(76) Inventors: Oh-Kee Kwon, Anyang-city (KR); Kang-Ho Kim, Daejeon-city (KR); Hyun-Soo Kim, Daejeon-city (KR); Jong-Hoi Kim, Daejeon-city (KR); Kwang-Ryong Oh, Daejeon-city (KR)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/699,176

(22) Filed: Oct. 30, 2003

(30) Foreign Application Priority Data
Dec. 12, 2002 (KR) 2002-79228

(51) Int. Cl. H01S 3/10; H01S 3/082

(52) U.S. Cl. 372/20; 372/97

(57) ABSTRACT

Disclosed is a tunable wavelength semiconductor laser diode which comprises a FP(fabry-parrot) laser diode array for producing at least two light beams, a combiner for combining the light beams output by an end of the laser diode array, a lens for collimating the light beams output by another end thereof, a grating for diffracting the light beams collimated by the lens, and a reflector for reflecting the light beams diffracted by the grating to feed the reflected light beams back to the laser diode array.

### CROSS REFERENCE TO RELATED APPLICATION

This application claims priority to and the benefit of Korea Patent Application No. 2002-79228 filed on Dec. 12, 2002 in the Korean Intellectual Property Office, the content of which is incorporated herein by reference.

### BACKGROUND OF THE INVENTION

(a) Field of the Invention

The present invention relates to a tunable wavelength semiconductor laser diode used for a light source in a WDM (wavelength division multiplexing) system. More specifically, the present invention relates to a tunable wavelength semiconductor laser diode for using in an external resonator type including a laser diode, a lens, a grating, and an external reflector, reflecting a beam output from the laser diode to the external reflector, and feeding the beam back to the semiconductor resonator, thereby tuning a wavelength of the output beam at a specific region.

(b) Description of the Related Art

In a WDM system, it is required for a tunable wavelength semiconductor light source to have a narrow spectral line width and wide wavelength tunability in an operation region so as to realize continuous wavelengths without mode hopping over a tuning range.

An external resonator type tunable wavelength laser diode advantageously has broader and more continuous wavelength tunability (>100 nm), narrow spectral line width (<2 MHz) by 1/10 to 1/100 times, and a high SMSR (side mode suppression ratio, >40 dB) than a distributed bragg reflector using a sampled grating, and in particular, a Littman type external resonator provides an unvaried direction of an output beam at the time of varying a wavelength thereby also obtaining good directivity.

As to a conventional configuration of the Littman type external resonator shown in FIG. 4, the light output from a FP (Fabry-Parrot) laser diode 2 is collimated by a lens 4 and provided to a grating 6, and angle and intensity of the diffracted beam induced by the grating are determined according to a wavelength and an angle of an incident beam, and a period of the grating 6. A corresponding diffraction principle follows the equation mλ=b(sin α+sin β) where m is a diffraction order, b is a period of a grating, α is an angle of incident beam, and β is an angle of the diffraction beam.

A 0-order diffraction beam by the grating is focused through an output end lens 8, and is coupled to a fiber 10, and the +1-order diffraction beam is reflected from an external reflector 12 and fed back to the laser diode 2. That is, when the reflector 12 is rotated, wavelengths vertically provided to a mirror surface of the reflector with respect to the +1-order diffraction beam of the grating 6 are selectively fed back to the laser diode 2.

In this instance, rotation Δθ of the reflector 12 is defined as the Δθ=Δβ since the rotation of the reflector is matched to the variation of the +1-order diffraction angle, and the variation of the +1-order diffraction angle in the equation is produced as Δβ=mΔλ/b cos β.

In further detail to the variation of the diffraction angle with reference to FIG. 5, when the beam B1 output from the laser diode 2 is provided with an angle α with respect to a perpendicular axis 6c of the grating surface, the +1-order diffraction beam is refracted by an angle of β with respect to the perpendicular axis 6c and vertically provided to the reflector 12, and the 0-order diffraction beam is diffracted with an angle of −α and output through the fiber 10.

The +1-order beam input to the reflector 12 is totally reflected to be a feedback beam B2 that is output with an angle of β with respect to the grating 6, the feedback beam B2 input to the grating 6 with the above-noted angle is refracted with an angle of α based on the above-described equation with the angle of β to be fed back to the laser diode 2, and the 0-order diffraction of the feedback beam B2 refracted with the angle of −β is lost.

In the above-mentioned process, when the reflector 12 is rotated, the angle a of the +1-order diffraction beam of the beam B1 vertically provided on the reflector is required to be changed, and hence, the wavelengths of the incident beams on the same angle of incidence are varied according to the diffraction principle.

In general in a WDM system with a wavelength of 1.55 μm, it is required to rotate a rotary variance Δθ of the reflector 12 by +2.1 degrees (a total of 4.2 degrees) in order to produce a wavelength tuning of 60 nm when the angle of incidence of the grating 6 is 80 degree and the period of the grating 6 is 1 μm.

The above-described external resonator type tunable wavelength laser diode with wavelength tuning characteristics that depend on the rotation of the reflector cannot avoid problems such as stability deterioration caused by mechanical vibration of the reflector at the time of tuning the wavelength of the laser diode, and accordingly, long-time reliability is lowered.

A multichannel laser diode array solves the above-noted problems caused by the mechanical vibration of the reflector.

FIG. 6 shows a general configuration of a multichannel FP laser diode array.

The basic configuration of FIG. 6 corresponds to that of FIG. 4, and in addition, a FP laser diode array 14 is adopted for a light source, a lens 4 is used to collimate beams output from the laser diode array 14, the 0-order diffraction beam is output as optical loss in a grating 6, and part of the +1-order diffraction beams that has passed through the fixed half mirror reflector 16 is output to the fiber 10 through a lens 18 and another part thereof is reflected and fed back.

A principle of a tunable wavelength on an array interval has been applied to the above-configured multi-channel laser diode. That is, as shown in FIG. 7, an angle of a beam provided to the grating surface a is varied according to an arrangement interval of the laser diode array 14, and corresponding equations are given as Δα=α1−α2=φ, and accordingly, it is given that D=ƒ tan Φ where D is an array interval, ƒ is a focal length, and Φ is a variance of an incident angle. For example, the wavelength interval of 0.8 nm (Δƒ=(C/λ²)Δλ where C is the speed of light, ƒ is a frequency, and λ is a wavelength) is needed so as to maintain the channel spacing of 100 GHz in the WDM system in the wavelength of 1.55 μm, and when the variance of the incident angle is given as 0.264 degrees (Δα=Δλ/d cos α where α is 80 degrees and d is given as 1 μm) and the focal length between the lens and the array is defined as 4.34 mm, the array distance D is produced as 20 μm.

The above-configured multi-channel FP laser diode array as a tunable wavelength laser diode provides stable tuning characteristics and high-speed operations since there is no need to drive and rotate the reflector. However, since a number of wavelength channels are proportionally corresponds to a number of arrays, it is necessary to increase the number of channels and that of arrays so as to widen the wavelength range, and a diameter of the lens and an area of the grating accordingly increase, and the total size of the device enlarges thereby restricting increase of the wavelength tuning range.

Referring to FIG. 8 for increasing the wavelength tuning range, a beam output from a DFB (distributed-feedback) laser diode array 14 is passed through a lens 4, it is reflected according to a rotary control by a reflector 12, and a wavelength output from a specific channel is only output to a fiber 10 through an output end lens 8.

This method advantageously provides a simple configuration for controlling the current injected to DFB laser diodes with different grating periods to tune wavelengths and change a direction of a reflector, but it is difficult to manufacture the desired DFB laser diode arrays, and it still remains as a problem to provide a huge volume of DFB laser diodes of as many as the number of wavelength channels.

As a result, the conventional single configuration of the DFB laser diode requires a grating with a precise period of substantially 1 μm, and fine rotary characteristics of a reflector, and the multichannel DFB laser diode array requires an increase of a diameter of a lens as the number of arrays increases, thereby limiting widening of a wavelength range, and it is needed to provide a huge amount of DFB laser diode arrays of as many as the number of channels.

### SUMMARY OF THE INVENTION

It is an advantage of the present invention to provide a tunable wavelength semiconductor laser diode for increasing a period of a grating (>1 μm) without requiring fine control of a reflector to thus realize a wide tuning range.

In one aspect of the present invention, a tunable wavelength semiconductor laser diode comprises: a laser diode array for producing at least two light beams; a combiner for combining the light beams output by an end of the laser diode array; a lens for collimating the light beams output by another end thereof; a grating for diffracting the light beams collimated by the lens; and a reflector for reflecting the light beams diffracted by the grating to feed the light beams back to the laser diode array.

The laser diode includes a multi-channel FP laser diode array.

The combiner has optical passive waveguide couplers such as a directional coupler and a MMI (Multi-Mode Interference) coupler.

A wavelength of the light beam output to the fiber is controlled by an arrangement interval of the laser diode array and a focal length of the lens.

In another aspect of the present invention, a tunable wavelength semiconductor laser diode comprises: a multi-channel FP laser diode array; an AWG (arrayed waveguide grating) structure for selecting one of the light beams output by an end of the multi-channel FP laser diode array, and outputting it to a fiber; a lens for collimating the light beam output by another end thereof; a grating for diffracting the beam collimated by the lens; and a reflector for reflecting the beam diffracted by the grating, and feeding the light beam to a FP-laser diode array.

### BRIEF DESCRIPTION OF THE DRAWINGS

The accompanying drawings, which are incorporated in and constitute a part of the specification, illustrate an embodiment of the invention, and, together with the description, serve to explain the principles of the invention:

FIG. 1 shows a schematic diagram of a multi-channel FP laser diode array of an external resonator type according to a first preferred embodiment of the present invention;

FIG. 2 shows a schematic diagram of a multi-channel FP laser diode array of an external resonator type according to a second preferred embodiment of the present invention;

FIG. 3 shows spectral characteristics of the device according to preferred embodiments of the present invention;

FIG. 4 shows a schematic diagram of a conventional Littman type tunable wavelength semiconductor laser diode;

FIG. 5 shows a schematic diagram of a 0-order diffracted beam and a +1-order diffracted beam between a grating and a reflector as to a beam provided to the grating of the device of FIG. 4;

FIG. 6 shows a schematic diagram of a conventional multi-channel FP laser diode array of an external resonator type;

FIG. 7 shows a schematic diagram of variations of incident angles to the grating according to an array interval and a focal distance; and

FIG. 8 shows a configuration of a conventional multi-channel DFB laser diode array.

### DETAILED DESCRIPTION OF THE PREFERRED EMBODIMENTS

In the following detailed description, only the preferred embodiment of the invention has been shown and described, simply by way of illustration of the best mode contemplated by the inventor(s) of carrying out the invention. As will be realized, the invention is capable of modification in various obvious respects, all without departing from the invention. Accordingly, the drawings and description are to be regarded as illustrative in nature, and not restrictive.

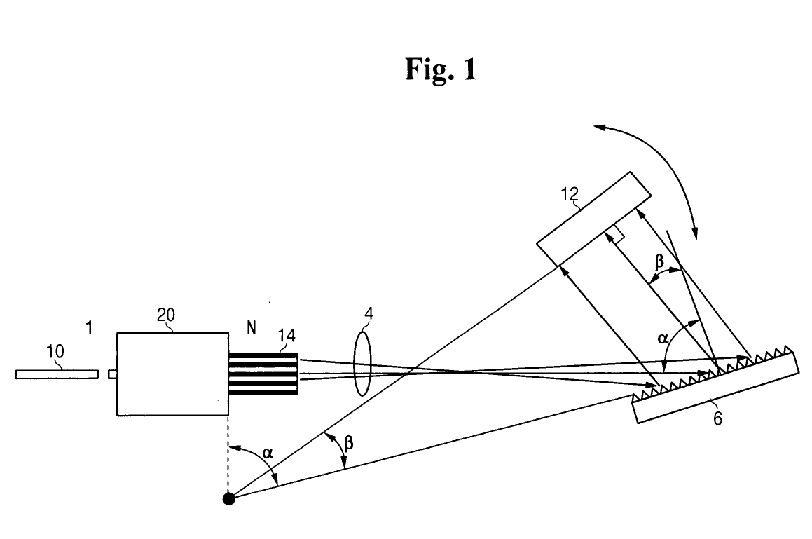

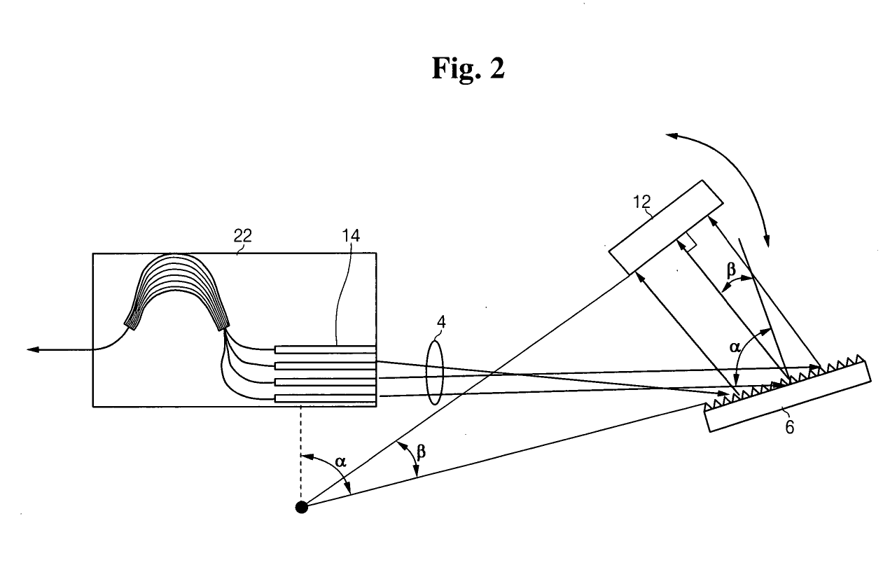

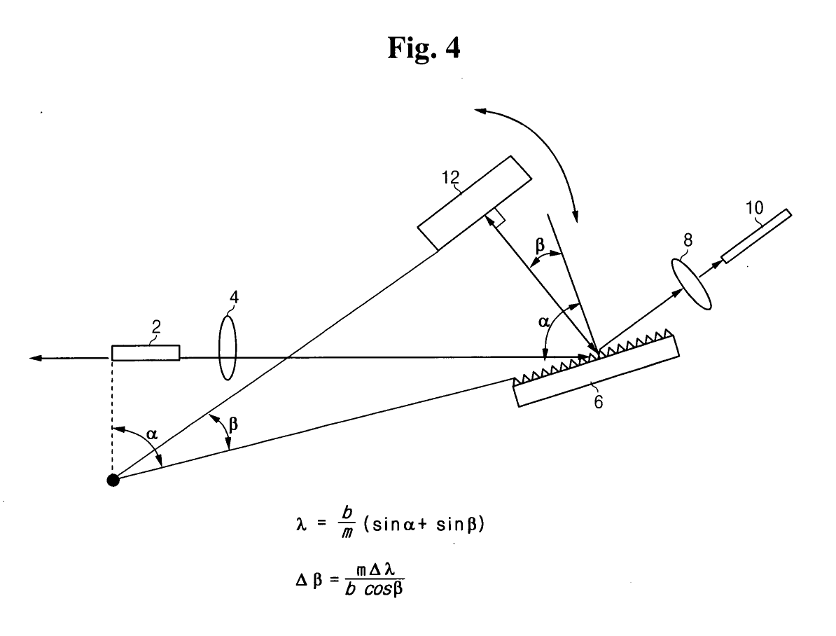

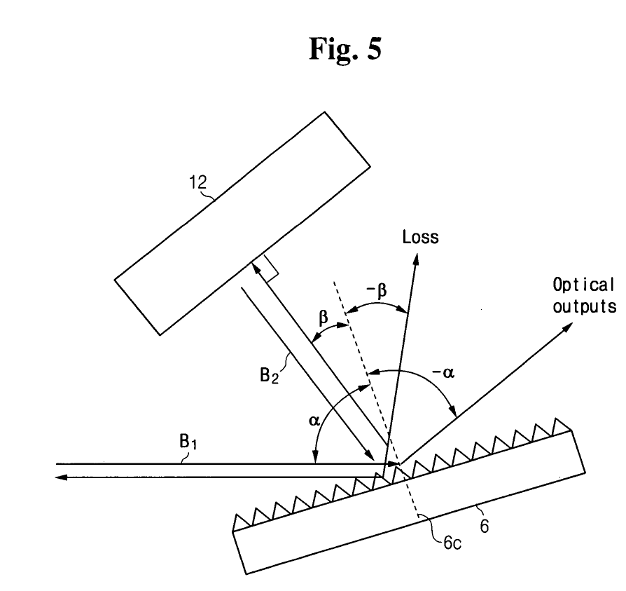

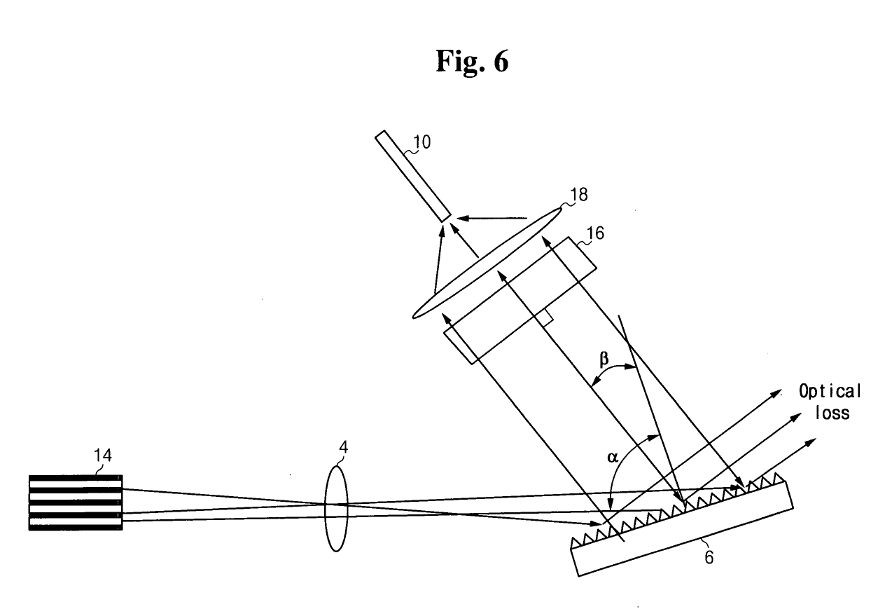

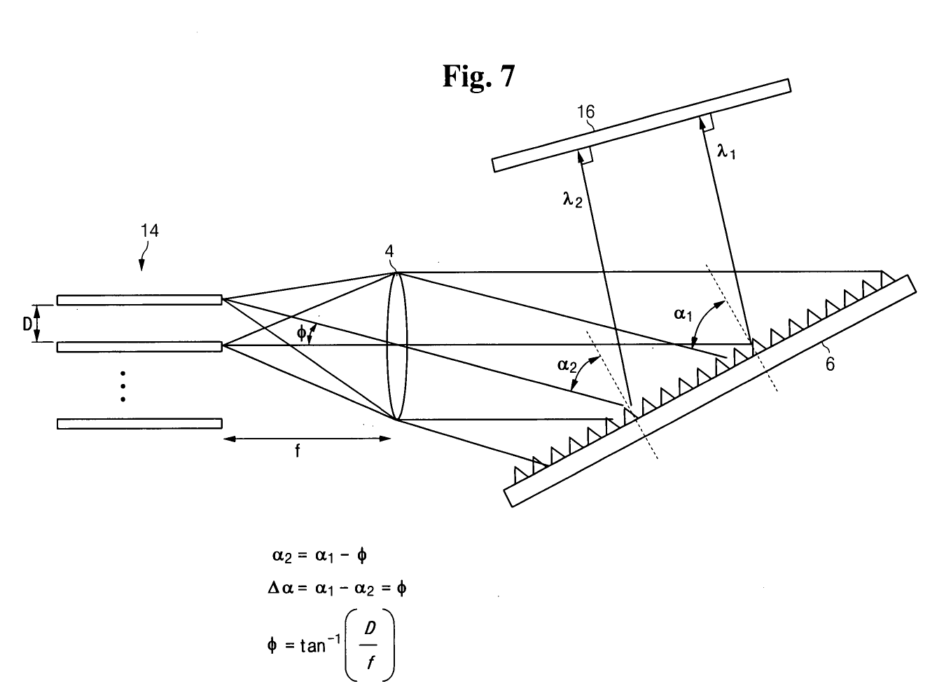

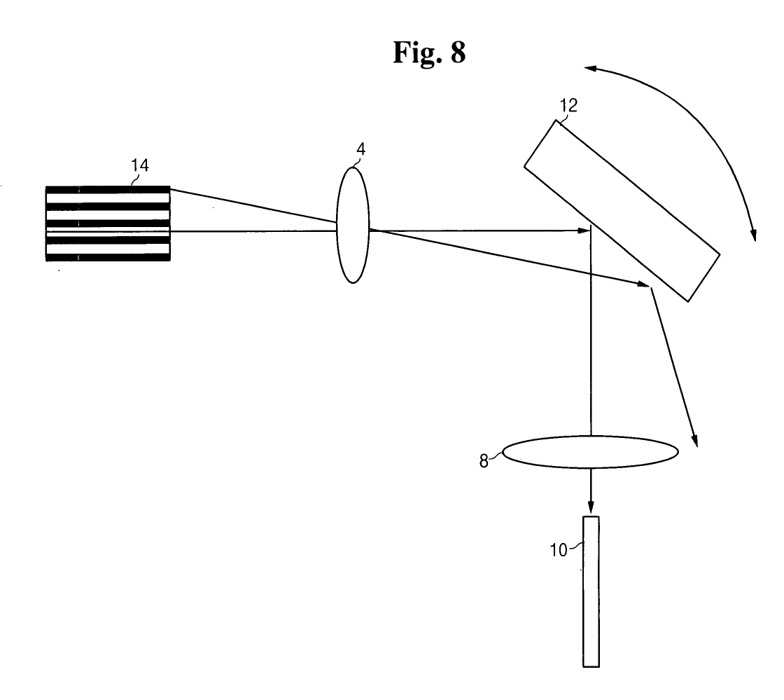

FIG. 1 shows a schematic diagram of a multi-channel FP laser diode array of an external resonator type according to a first preferred embodiment of the present invention, and it uses the same reference numerals as those of the conventional configurations shown in FIGS. 4 to 8 so as to escape the need for repeated descriptions.

A combiner 20 is inserted to an output end of a multi-channel FP laser diode array 14, and a fiber 10 is provided to an output end of the combiner 20. A light beam output from the multi-channel FP laser diode array 14 is collimated while passing through a lens 4 and diffracted and provided to a grating 6, and the diffracted light beam is reflected again from a reflector 12 and fed back to the multi-channel FP laser diode array 14. The combiner 20 does not use the light beam output from the 0-order term of the grating 6 as an optical output, but uses a light beam (the left side of the figure) output from each channel of the multi-channel FP laser diode array 14, and accordingly, it is convenient to arrange the combiner 20 with the fiber 10 and package them.

Further, since the above configuration allows controlling a tunable wavelength through an arrangement interval of the multi-channel FP laser diode array 14 and a focal length of the lens 4, and concurrently enables controlling the tunable wavelength through rotation of the reflector 12 based on the diffraction phenomenon of the grating, the above configuration realizes a wide tunable wavelength range.

The combiner 20 has an optical passive waveguide coupler or adopts an optical waveguide coupler of the MMI (multi-mode interface) type.

The combiner 20 generates coupling loss in proportion to a number of channels, and the MMI coupler remarkably causes the coupling loss in the multi-channel configuration having more than eight channels, but serious problems such as damage to the actual use can be escaped through a careful design.

FIG. 2 shows a schematic diagram of a multi-channel FP laser diode array of an external resonator type according to a second preferred embodiment of the present invention. In this embodiment, an AWG (array waveguide grating) 22 is used as the combiner 20.

The AWG 22 is a multiplexer having wavelength selectivity for each output end, and it slightly differentiates channel lengths of the array optical waveguide range on the light beams provided to respective channels with the same interval. According to this configuration, phase variation is generated while a light beam in a medium is propagating, constructive or destructive interferences occur in each output end, and hence, a specific wavelength is selected and output to each output channel.

The AWG 22 has very low coupling loss characteristics compared to the MMI coupler.

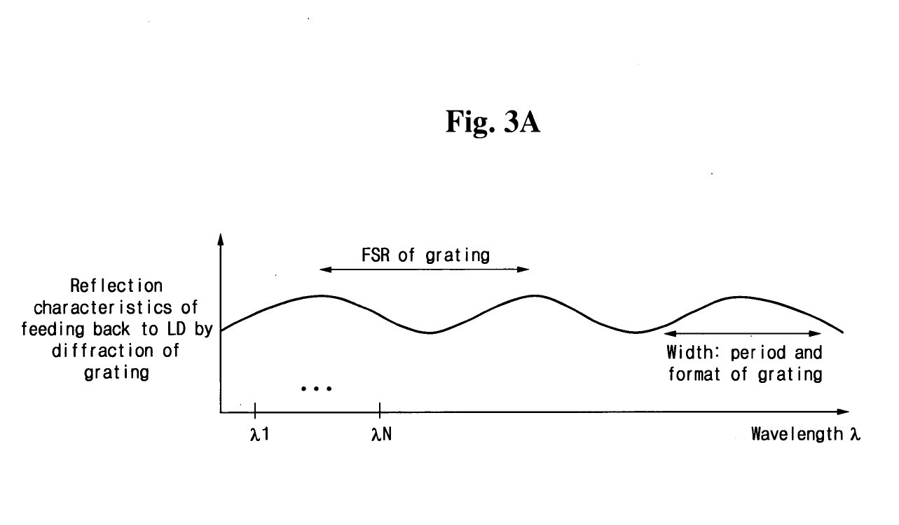

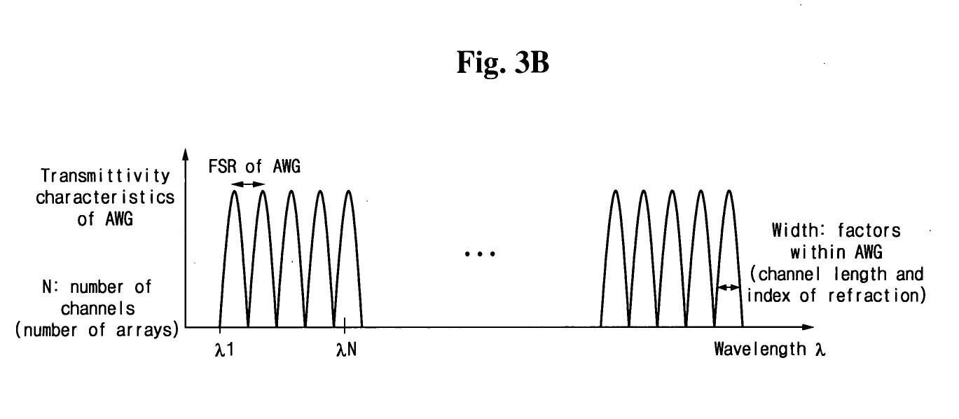

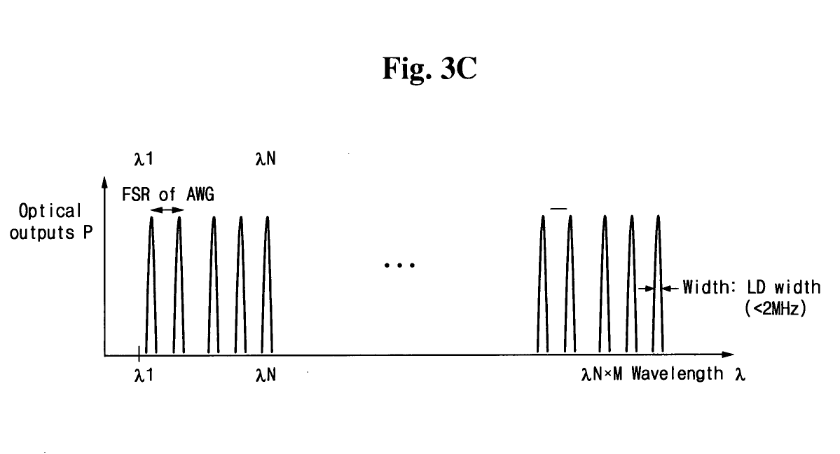

FIGS. 3(a) through 3(c) show spectral characteristics of optical outputs caused by the multi-channel FP laser diode array which adopts the AWG 22.

As shown, FIG. 3(a) shows that an FSR (free spectral range) of the grating 6 is generated by rotation of the reflector 12, and a spectral width is determined by the grating period and format.

In this preferred embodiment, a wavelength interval between channels can be controlled by an array interval of the multi-channel FP laser diode 14 and a focal length of the lens 4.

FIG. 3(b) shows transmittivity characteristics of the AWG 22, and the FSR and the spectral width are determined according to factors including a number of channels, lengths of optical waveguides, and a refractive index in the AWG 22.

The above-noted configuration shows that optical outputs can be corrected because of wavelength selectivity of the AWG even though the wavelength selectivity is not accurate with respect to a channel interval and rotation of the reflector in the case the grating period is relatively wide, and indicates that no fine tuning between a tuning mirror and an array element is needed, thereby providing an excellent yield and element reliability.

FIG. 3(c) shows wavelength characteristics of optical outputs generated by an output end of the AWG 22, showing that a number N×M of channels is obtained when a number of channels is N and rotation of the reflector is performed M times.

In the above-described device, the configuration by the AWG 22 requires no crosstalk and PDL (polarization dependent loss) characteristics of the AWG, since the light beams output from laser diode array have TE (transverse electric) polarization, thereby easily realizing the device.

As described, since the tunable wavelength semiconductor laser diode outputs optical outputs through the combiners, arrangements with the fiber are easily executed. In particular, since the usage of an AWG substantially reduces coupling loss, no fine tuning of a reflector, arrangement interval of a multi-channel FP laser diode array, or accuracy of a focal length of a lens are required, thereby simplifying packaging and improving yields and element reliabilities.

Since a multi-channel FP laser diode array is provided to a external resonator type light source for generating a tunable wavelength by rotation of a reflector, and one of a combiner is added to an array output end, characteristics of continuous tunable wavelengths, narrow widths, and high single modes are obtained, packaging is easily performed, and stable variable wavelength features are provided.

In addition, since no fining tuning of a reflector and accuracy of an array interval and a focal distance are required, yields and reliabilities are greatly enhanced.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

What is claimed is:

1. A tunable wavelength semiconductor laser diode comprising:
a laser diode array for producing at least two light;
a combiner for combining the light beams output by an end of the laser diode array;
a lens for collimating the light beams output by another end thereof;
a grating for diffracting the light beams collimated by the lens; and
a reflector for reflecting the light beams diffracted by the grating to feed the reflected light beams back to the laser diode array.

2. The laser diode of claim 1, wherein the laser diode includes a multi-channel FP (fabry-parrot) laser diode array.

3. The laser diode of claim 1, wherein the combiner has an optical waveguide configuration or an MMI (multimode interface) type passive optical waveguide configuration.

4. The laser diode of claim 1, wherein a wavelength of the light beam output to the fiber is controlled by an arrangement interval of the laser diode array.

5. The laser diode of claim 1, wherein a wavelength of the light beam output to the fiber is controlled by a focal length of the lens.

6. A tunable wavelength semiconductor laser diode comprising:
a multi-channel diode array for producing at least two light;
an AWG (array wavelength grating) for selecting one of the light beams output by an end of the multi-channel diode array, and outputting it to a fiber;
a lens for collimating the light beam output by another end thereof;
a grating for diffracting the beam collimated by the lens; and
a reflector for reflecting the beam diffracted by the grating, and feeding the light beam to a FP (fabry-parrot) laser diode array.
